(19) United States
(12) Patent Application Publication
(10) Pub. No.: US 2016/0195766 A1
(43) Pub. Date: Jul. 7, 2016

(54) PLASMONIC COLOR POLARIZER AND EMISSIVE TYPE DISPLAY INCLUDING THE SAME

(71) Applicant: Samsung Display Co., Ltd., Yongin-si (KR)

(72) Inventors: Young Min KIM, Yongin-si (KR); Dong-Uk KIM, Hwaseong-si (KR); Hae Il PARK, Seoul (KR); Seon-Tae YOON, Seoul (KR); Kwang Keun LEE, Osan-si (KR)

(21) Appl. No.: 14/855,831

(22) Filed: Sep. 16, 2015

(30) Foreign Application Priority Data
Jan. 6, 2015 (KR) 1020150001275

(51) Int. Cl. G02F 1/1335; G02B 5/30

(52) U.S. Cl. CPC G02F 1/133533; G02B 5/3025; G02F 1/133512; G02F 1/133514

(57) ABSTRACT

An emissive type display device includes: a first insulation substrate; a light conversion layer formed proximate to an inner surface of the first insulation substrate; a plasmonic color polarization layer formed on the light conversion layer; a second insulation substrate having an inner surface that faces the inner surface of the first insulation substrate; and a liquid crystal layer interposed between the inner surfaces of the first insulation substrate and the second insulation substrate. The plasmonic color polarization layer is configured to polarize and transmit light having wavelengths within a first wavelength range, and to reflect light having wavelengths within a second wavelength range.

### CROSS-REFERENCE TO RELATED APPLICATION

This application claims priority to, and the benefit of, Korean Patent Application No. 10-2015-0001275 filed in the Korean Intellectual Property Office on Jan. 6, 2015, the entire contents of which are incorporated herein by reference.

### BACKGROUND

(a) Technical Field

This disclosure relates generally to flat panel displays. This disclosure relates more specifically to a plasmonic color polarizer and an emissive type display device including the same.

(b) Description of the Related Art

Various types of flat panel displays exist, including liquid crystal displays (LCDs), organic light emitting diode (OLED) displays, and the like. Among these types of displays, LCDs are currently the most widely used flat panel displays. An LCD consists of two substrates with electrodes formed thereon, with a liquid crystal layer interposed therebetween. The LCD controls an amount of transmitted light by applying signals to the electrodes to realign liquid crystal molecules of the liquid crystal layer.

One common problem with LCDs is that images look different when viewed from the front of the display as they do when viewed from the sides. This is because the amount of transmitted light varies depending on paths of light transmitted through the liquid crystal layer.

In contrast, an OLED display realizes high color reproducibility as the organic light emitting elements of each pixel emit light themselves. They thus provide a wide viewing angle.

However, the OLED has its own challenges. For example, they require relatively complex circuits for driving their pixels, and as they are current-driven, display quality is very sensitive to degradation of thin film transistors.

The above information disclosed in this Background section is only for enhancement of understanding of the background of the invention and therefore it may contain information that does not form the prior art that is already known in this country to a person of ordinary skill in the art.

### SUMMARY

An exemplary embodiment of the present invention provides an emissive type display device having desirable characteristics of both a liquid crystal display (LCD) and an organic light emitting diode (OLED) display.

An exemplary embodiment of the present invention acts to improve light utilization efficiency in an emissive type display device.

An exemplary embodiment of the present invention also provides a more simplified structure for an emissive type display device. A plasmonic color polarizer according to an exemplary embodiment of the present invention includes a plurality of bars each having a predetermined width and each comprising: a first metal layer; a dielectric layer laminated on the first metal layer; and a second metal layer laminated on the dielectric layer. The bars are arranged to be oriented substantially parallel to each other and adjacent bars are spaced apart from each other by a predetermined interval, so that light having wavelengths within a first wavelength range is polarized while passing between adjacent bars, and so that light having wavelengths within a second wavelength range is reflected from the bars.

The first wavelength range may be a blue wavelength range, and the second wavelength range may include substantially an entire visible-ray range other than the blue wavelength range.

The predetermined interval may be from about 600 nm to about 700 nm, and the predetermined width may be from about 90 nm to about 190 nm.

The first and second metal layers may include aluminum or silver, and the dielectric material may include zinc selenide (ZnSe) or a dielectric material having a dielectric constant difference of about 0.1 or less with respect to ZnSe.

Thicknesses of the first and second metal layers may be from about 30 nm to about 50 nm, and a thickness of the dielectric material may be from about 50 nm to about 70 nm.

A display device according to an exemplary embodiment of the present invention includes: a first insulation substrate; a light conversion layer formed proximate to an inner surface of the first insulation substrate; a plasmonic color polarization layer formed on the light conversion layer; a second insulation substrate having an inner surface that faces the inner surface of the first insulation substrate; and a liquid crystal layer interposed between the inner surfaces of the first insulation substrate and the second insulation substrate. The plasmonic color polarization layer is configured to polarize and transmit light having wavelengths within a first wavelength range, and to reflect light having wavelengths within a second wavelength range.

The display device according to the exemplary embodiment of the present invention may further include: a common electrode formed on the plasmonic color polarization layer; and a plurality of pixel electrodes and thin film transistors formed on the second insulation substrate.

The plasmonic color polarization layer may include a plurality of bars each having a predetermined width and each comprising: a first metal layer; a dielectric layer laminated on the first metal layer; and a second metal layer laminated on the dielectric layer. Adjacent bars may be arranged to be oriented substantially parallel to each other and spaced apart from each other by a predetermined interval.

The first wavelength range may be a blue wavelength range, and the second wavelength range may include substantially an entire visible-ray range other than the blue wavelength range.

The predetermined interval may be from about 600 nm to about 700 nm, and the predetermined width may be from about 90 nm to about 190 nm.

The first and second metal layers may include aluminum or silver, and the dielectric material may include zinc selenide (ZnSe) or a dielectric material having a dielectric constant difference of about 0.1 or less with respect to ZnSe.

Thicknesses of the first and second metal layers may be from about 30 nm to about 50 nm, and a thickness of the dielectric material may be from about 50 nm to about 70 nm.

The light conversion layer may include a red light conversion layer for converting blue light into red light and a green light conversion layer for converting blue light into green light.

A light blocking layer disposed between the red light conversion layer and the green light conversion layer may be further included.

When using a plasmonic color polarizer constructed according to an exemplary embodiment of the present invention, there is no need for a separate polarization layer and reflective layer that separately perform a polarizing function for blue light and a reflecting function for green and red light. Thus, when applying the plasmonic color polarizer to the emissive type display device, the structure of the emissive type display device and its manufacturing process can be simplified.

### BRIEF DESCRIPTION OF THE DRAWINGS

FIG. 1 is a cross-sectional view of an emissive type display device according to an exemplary embodiment of the present invention.

FIG. 2 is a perspective view of a plasmonic color polarizer according to an exemplary embodiment of the present invention.

FIG. 3 is a graph for illustrating transmission and reflection spectra according to wavelengths and modes of the plasmonic color polarizer constructed according to an exemplary embodiment of the present invention.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. The various figures are not to scale. All numerical values given herein are approximate, and may vary.

An emissive type display device according to an exemplary embodiment of the present invention will now be described in detail with reference to the drawings.

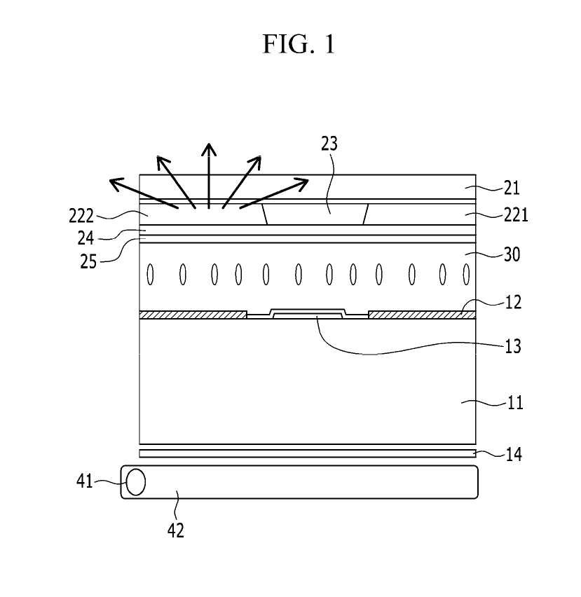

FIG. 1 is a cross-sectional view of an emissive type display device according to an exemplary embodiment of the present invention.

Referring to FIG. 1, an emissive type display device according to an exemplary embodiment of the present invention includes a backlight unit and a liquid crystal panel. The backlight unit includes a blue light source 41 for emitting blue light, and a light guide 42 for distributing the blue light emitted by the blue light source so that it appears emitted by the plane formed by the upper surface of light guide 42.

The liquid crystal panel includes: a transparent lower substrate 11; a pixel electrode 12 formed on the lower substrate 11; a thin film transistor 13 formed on the lower substrate 11 to switch the voltage applied to pixel electrode 12; a transparent upper substrate 21; a red light-emitting element 221 and a green light emitting element 222 formed on a lower surface of the upper substrate 21; a light blocking member 23 disposed between the red light-emitting element 221 and the green light emitting element 222; a plasmonic color polarizer 24 disposed below the red light-emitting element 221, the green light emitting element 222, and the light blocking member 23; a common electrode 25 disposed below the plasmonic color polarizer 24; and a liquid crystal layer 30 filling a space between the pixel electrode 12 and the common electrode 25.

In this case, the red light-emitting element 221 may include a quantum dot material or a fluorescent material that receives blue light and emits red light (i.e. converts other-colored light to red light), and the green light-emitting element 222 may include a quantum dot material or a fluorescent material that receives blue light and emits green light (i.e. converts other-colored light to green light). In other words, the red light-emitting element 221 and the green light emitting element 222 are light conversion layers for converting incident light into light of specified wavelengths.

In blue pixels, instead of the red light-emitting element 221 and the green light emitting element 222, a filler (not shown) formed of a transparent insulating material may be disposed.

A polarization film 14 is disposed between the liquid crystal panel and the backlight unit. In addition to the polarization film 14, a diffusion film, a prism film, a phase difference film, etc. may be disposed between the liquid crystal panel and the backlight unit.

In the emissive type display device, the plasmonic color polarizer 24 polarizes and then transmits blue light, and reflects most green light and red light. A polarization axis of the plasmonic color polarizer 24 and a polarization axis of the polarization film 14 may be substantially perpendicular to each other.

In the emissive type display device, blue light emitted by the backlight unit is linearly polarized while passing through the polarization film 14, and this linearly polarized blue light passes through the plasmonic color polarizer 24 after it is differently polarized while passing through the liquid crystal layer 30. An amount of the blue light transmitted through the plasmonic color polarizer 24 thus varies depending on its polarization state.

The blue light transmitted through the plasmonic color polarizer 24 activates the red light-emitting element 221 and the green light emitting element 222 to emit red and green light, respectively.

In this case, the red and green light emitted from the red light-emitting element 221 and the green light emitting element 222 are partially emitted toward the plasmonic color polarizer 24 because the two light-emitting elements emit light in all directions. The plasmonic color polarizer 24 reflects and returns this red and green light back toward the upper substrate 21 such that otherwise-lost red and green light is instead used for display purposes.

As above, the blue pixel is made of a transparent material. Thus, blue light that enters the blue pixel passes therethrough so as to display a blue image.

Accordingly, in the emissive type display device according to the exemplary embodiment of the present invention, blue light is polarized and transmitted through the blue pixels, while the red and green light make use of the plasmonic color polarizer for more efficient light transmission, thereby improving light utilization efficiency of the emissive type of display device and simplifying the structure of the emissive type of display device.

The plasmonic color polarizer will now be described in more detail.

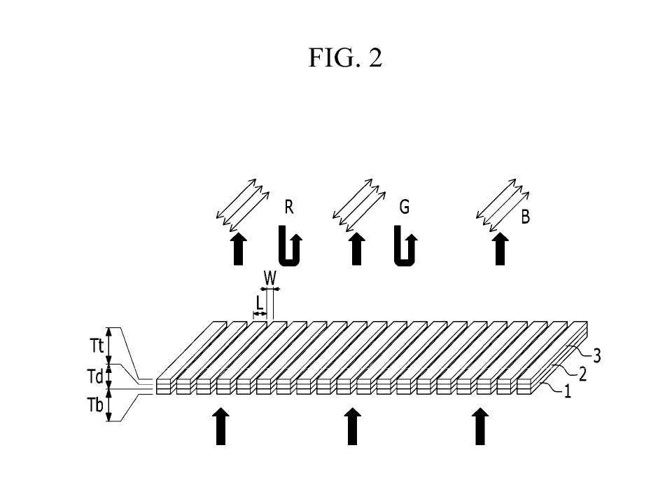

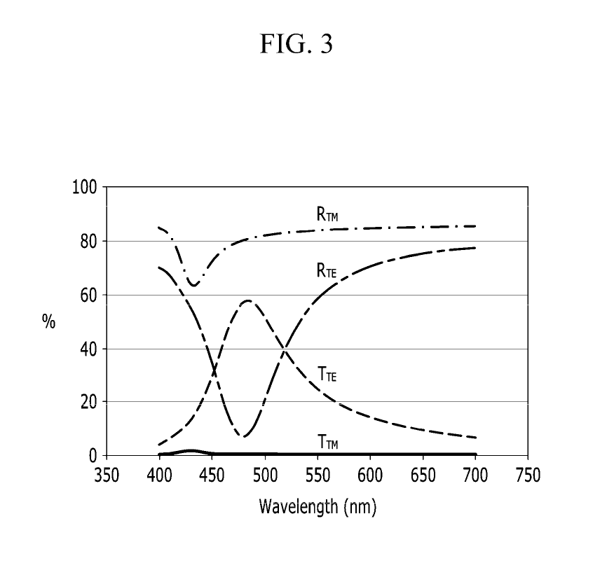

FIG. 2 is a perspective view of the plasmonic color polarizer according to the exemplary embodiment of the present invention, and FIG. 3 is a graph illustrating transmission and reflection spectra as a function of wavelengths and modes of the plasmonic color polarizer according to the exemplary embodiment of the present invention.

Referring to FIG. 2, the plasmonic color polarizer according to the exemplary embodiment of the present invention includes a plurality of bars that each have two metal layers 1 and 3 with a dielectric material layer 2 interposed between the two metal layers 1 and 3.

The bars each have a fixed width L, and are arranged parallel to each other while having a fixed interval or space W therebetween.

In this case, the plurality of bars may have a width L of about 90 nm to about 190 nm, and may have an interval W between adjacent bars of about 600 nm to about 700 nm.

It is preferred that the plurality of bars be arranged to have the width and the interval described above, so that desired amounts of a polarizing function for the blue light and a reflecting function for the red and green light can occur.

Thicknesses Tb and Tt of the two metal layers 1 and 3 forming the bars may be about 30 nm to about 50 nm, respectively, and a thickness Td of the dielectric material 2 may be about 50 nm to about 70 nm.

The two metal layers 1 and 3 may be formed of aluminum or silver, and the dielectric material 2 may be formed of zinc selenide (ZnSe) or any dielectric material having a dielectric constant difference of about 0.1 or less with respect to ZnSe. The plasmonic color polarizer may be formed by sequentially laminating the material of the lower metal layer 1, the dielectric layer 2, and the upper metal layer 3 and then performing a photolithography process such as near-field or superlens photolithography.

In alternative embodiments, instead of a photosensitive material, di-block copolymers having different lengths may be used for patterning. Similarly, a nano-imprinting process may be used to form the plasmonic color polarizer.

FIG. 3 is a simulation result showing transmission and reflection characteristics according to wavelengths and modes by designing the plasmonic color polarizer such that the two metal layers 1 and 3 are about 40 nm thick, the dielectric layer 2 is about 60 nm thick, the bar has a width of about 140 nm, and an interval between the bars is about 650 nm, and then by irradiating white light thereto.

According to FIG. 3, light of a transverse magnetic (TM) mode has little transmitted light (T_{TM}) and is mostly reflected to become reflected light (R_{TM}).

Light of a transverse electric (TE) mode has a large amount of transmitted light (T_{TE}) in a blue light range (450 nm to 520 nm), and has a large amount of reflected light (R_{TE}) in the other ranges. In other words, the plasmonic color polarizer transmits only the blue light of the TE mode and reflects most of the other light components. Accordingly, it can be seen that the plasmonic color polarizer polarizes blue light and reflects red and green light.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A plasmonic color polarizer comprising:
a plurality of bars each having a predetermined width and each comprising:
a first metal layer;
a dielectric layer laminated on the first metal layer; and
a second metal layer laminated on the dielectric layer;
wherein the bars are arranged to be oriented substantially parallel to each other and adjacent bars are spaced apart from each other by a predetermined interval, so that light having wavelengths within a first wavelength range is polarized while passing between adjacent bars, and so that light having wavelengths within a second wavelength range is reflected from the bars.

2. The plasmonic color polarizer of claim 1, wherein the first wavelength range is a blue wavelength range, and the second wavelength range includes substantially an entire visible-ray range other than the blue wavelength range.

3. The plasmonic color polarizer of claim 2, wherein the predetermined interval is from about 600 nm to about 700 nm, and the predetermined width is from about 90 nm to about 190 nm.

4. The plasmonic color polarizer of claim 3, wherein the first and second metal layers include aluminum or silver, and the dielectric material includes zinc selenide (ZnSe) or a material having a dielectric constant difference of about 0.1 or less with respect to ZnSe.

5. The plasmonic color polarizer of claim 4, wherein thicknesses of the first and second metal layers are from about 30 nm to about 50 nm, and a thickness of the dielectric material is from about 50 nm to about 70 nm.

6. A display device comprising:
a first insulation substrate;
a light conversion layer formed proximate to an inner surface of the first insulation substrate;
a plasmonic color polarization layer formed on the light conversion layer;
a second insulation substrate having an inner surface that faces the inner surface of the first insulation substrate; and
a liquid crystal layer interposed between the inner surfaces of the first insulation substrate and the second insulation substrate,
wherein the plasmonic color polarization layer is configured to polarize and transmit light having wavelengths within a first wavelength range, and to reflect light having wavelengths within a second wavelength range.

7. The display device of claim 6, further comprising:
a common electrode formed on the plasmonic color polarization layer; and
a plurality of pixel electrodes and thin film transistors formed on the second insulation substrate.

8. The display device of claim 7, wherein the plasmonic color polarization layer includes a plurality of bars each having a predetermined width and each comprising:
a first metal layer;
a dielectric layer laminated on the first metal layer; and
a second metal layer laminated on the dielectric layer;
wherein adjacent bars are arranged to be oriented substantially parallel to each other and spaced apart from each other by a predetermined interval.

9. The display device of claim 8, wherein the first wavelength range is a blue wavelength range, and the second wavelength range includes substantially an entire visible-ray range other than the blue wavelength range.

10. The display device of claim 9, wherein the predetermined interval is from about 600 nm to about 700 nm, and the predetermined width is from about 90 nm to about 190 nm.

11. The display device of claim 10, wherein the first and second metal layers include aluminum or silver, and the dielectric material includes zinc selenide (ZnSe) or a material having a dielectric constant difference of about 0.1 or less with respect to ZnSe.

12. The display device of claim 11, wherein thicknesses of the first and second metal layers are from about 30 nm to about 50 nm, and a thickness of the dielectric material is from about 50 nm to about 70 nm.

13. The display device of claim 9, wherein the light conversion layer includes a red light conversion layer for converting blue light into red light and a green light conversion layer for converting blue light into green light.

14. The display device of claim 13, further comprising a light blocking layer disposed between the red light conversion layer and the green light conversion layer.
